(19) United States
(12) Patent Application Publication
(10) Pub. No.: US 2006/0087293 A1
(43) Pub. Date: Apr. 27, 2006

(54) AC generator with independently controlled field rotational speed

(75) Inventors: Mingzhou Xu, Tucson, AZ (US); Dwayne M. Benson, Chandler, AZ (US); Wayne T. Pearson, Tucson, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/111,084

(22) Filed: Apr. 20, 2005

Related U.S. Application Data
(60) Provisional application No. 60/622,495, filed on Oct. 26, 2004.

(51) Int. Cl. H02P 9/10; H02P 9/14

(52) U.S. Cl. 322/59

(57) ABSTRACT

A generator system is configured to supply relatively constant frequency AC power when driven by a variable speed prime mover, by independently controlling the main rotor flux rotational speed. The generator system includes an exciter stator that induces current in the exciter rotor windings at a desired frequency and phasing. The exciter rotor windings are electrically connected to the main rotor windings, and are thus electrically excited at the same frequency and phasing. Excitation is supplied to the exciter stator from an exciter controller, which controls the frequency and phasing of the exciter excitation, based on the rotational speed of the generator, to maintain a constant output frequency.

### CROSS-REFERENCES TO RELATED APPLICATIONS

This application claims the benefit of U.S. Provisional Application No. 60/622,495, filed Oct. 26, 2004.

### TECHNICAL FIELD

The present invention relates to AC generators and, more particularly, to AC generators with independently controlled field rotational speeds, to thereby supply a relatively constant frequency AC voltage under varying mechanical rotational speeds.

### BACKGROUND

Many aircraft include AC generator systems to supply relatively constant frequency AC power. Many of the AC generator systems installed in aircraft include three separate brushless generators, namely, a permanent magnet generator (PMG), an exciter, and a main generator. The PMG includes a rotor having permanent magnets mounted thereon, and a stator having a plurality of windings. When the PMG rotor rotates, the permanent magnets induce AC currents in PMG stator windings. These AC currents are typically fed to a regulator or a control device, which in turn outputs a DC current to the exciter.

The exciter typically includes single-phase (e.g., DC) stator windings and multi-phase (e.g., three-phase) rotor windings. The DC current from the regulator or control device is supplied to exciter stator windings, and as the exciter rotor rotates, three phases of AC current are typically induced in the rotor windings. Rectifier circuits that rotate with the exciter rotor rectify this three-phase AC current, and the resulting DC currents are provided to the main generator. The main generator additionally includes a rotor and a stator having single-phase (e.g., DC) and multi-phase (e.g., three-phase) windings, respectivley. The DC currents from the rectifier circuits are supplied to the rotor windings. Thus, as the main generator rotor rotates, three phases of AC current are induced in main generator stator windings. This three-phase AC current can then be provided to a load such as, for example, electrical aircraft systems.

Many AC generators that are installed in aircraft, such as the generator described above, are driven by variable speed prime movers. For example, many generators are driven by the aircraft engines, which may vary in rotational speed during operation. Thus, to ensure the AC generators supply relatively constant frequency AC power, many aircraft include a hydraulic transmission, or other type of gear arrangement, that converts the variable engine speed to a relatively constant rotational speed.

Although the above-described configuration is generally safe, it does suffer certain drawbacks. For example, hydraulic transmissions can be relatively large, heavy, complex, and/or may exhibit relatively poor reliability. Each of these factors can lead to increased overall aircraft, fuel, and maintenance costs, and/or increased maintenance frequency, which can further lead to increased costs.

One solution to the above-noted drawbacks is disclosed in U.S. Pat. No. 6,188,204. The solution disclosed therein employs main windings and auxiliary windings disposed on the same rotor. The auxiliary windings are supplied with adjustable frequency AC power, and in turn excite the main windings to produce a desired output frequency. Although this solution does work, it also suffers certain drawbacks in that the main and auxiliary windings are arranged to be magnetically decoupled by having a specified numbers of poles that are configured such that one pole of one set of windings encompasses one or more pairs of poles of the other set of windings. This can lead to complexity in design and implementation.

Hence there is a need for a system and method of supplying relatively constant frequency AC power from a generator that is driven by a variable speed prime mover that is a relatively small, lightweight, less complex, and/or reliable, as compared to current systems and methods, and that does not rely on specified numbers of exciter and main generator poles. The present invention addresses one or more of these needs.

### BRIEF SUMMARY

The present invention provides a generator system that supplies relatively constant frequency AC power from a generator that is driven by a variable speed prime mover by independently controlling the field rotational speeds.

In one embodiment, and by way of example only, a generator system includes a main generator rotor, an exciter rotor, an exciter stator, and an exciter controller. The main generator rotor is configured to rotate at a variable rotational speed, and has a plurality of main generator rotor windings wound thereon that, upon electrical excitation thereof, generate an electromagnetic flux. The exciter rotor is configured to rotate at the variable rotational speed, and has a plurality of exciter rotor windings wound thereon. The exciter rotor windings are electrically connected to the main generator rotor windings and are configured, upon electrical excitation thereof, to supply the electrical excitation to the main generator rotor windings. The exciter stator surrounds at least a portion of the exciter rotor, and has a plurality of exciter stator windings wound thereon. The exciter stator windings are configured, upon electrical excitation thereof, to electrically excite the exciter rotor windings. The exciter controller is electrically coupled to at least the exciter stator windings, and is configured to determine the rotational speed of the main generator rotor and the exciter rotor and, based on the determined rotational speed, to supply electrical excitation to the exciter stator windings that results in the main generator rotor windings generating the electromagnetic flux at a substantially constant, predetermined frequency.

Other independent features and advantages of the preferred generator system and method will become apparent from the following detailed description, taken in conjunction with the accompanying drawings which illustrate, by way of example, the principles of the invention.

### BRIEF DESCRIPTION OF THE DRAWINGS

FIG. 1 is a functional block diagram of an exemplary high speed generator system according to an embodiment of the present invention;

FIG. 2 is a functional block diagram of an exemplary high speed generator system according to an alternative embodiment of the present invention;

FIG. 3 is a perspective view of a physical embodiment of the high speed generator shown in FIGS. 1 and 2; and

FIG. 4 is a schematic representation of at least a portion of the high speed generators of FIGS. 1 and 2.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

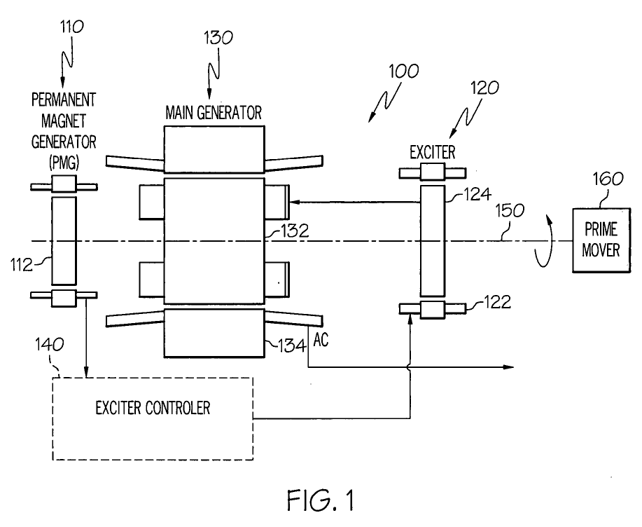

Turning now to the description and with reference first to FIG. 1, a functional schematic block diagram of an exemplary high speed generator system 100 for use with, for example, an aircraft gas turbine engine, is shown. This exemplary generator system 100 includes a permanent magnet generator (PMG) 110, an exciter 120, a main generator 130, and an exciter controller 140. It will be appreciated that the generator system 100 may include one or more additional components, sensors, or controllers. However, a description of these additional components, sensors, and controllers, if included, is not needed, and will therefore not be further depicted or described.

In the depicted embodiment, a rotor 112 of the PMG 110, a rotor 124 of the exciter 120, and a rotor 132 of the main generator 130 are all mounted on a common drive shaft 150. The drive shaft 150 receives a rotational drive force from a prime mover 160, such as an aircraft gas turbine engine, which causes the PMG rotor 112, the exciter rotor 124, and the main generator rotor 132 to all rotate at the same rotational speed. As was noted, the rotational speed of the prime mover 160, and thus these generator system components, varies. For example, in one embodiment described in more detail further below, the rotational speed varies in the range of about 1,200 rpm to about 4,800 rpm. It will be appreciated that this rotational speed range is merely exemplary, and that various other speed ranges may be used.

No matter the specific rotational speed range, it will be appreciated that as the PMG rotor 112 rotates, the PMG 110 generates and supplies, via a PMG stator 114, AC power to the exciter controller 140. In response, the exciter controller 140 supplies AC power to a stator 122 of the exciter 120. In turn, this causes the exciter rotor 124 to supply AC power to the main generator rotor 132. As the main generator rotor 132 rotates, it induces AC current in a main generator stator 134, which is in turn supplied to one or more loads.

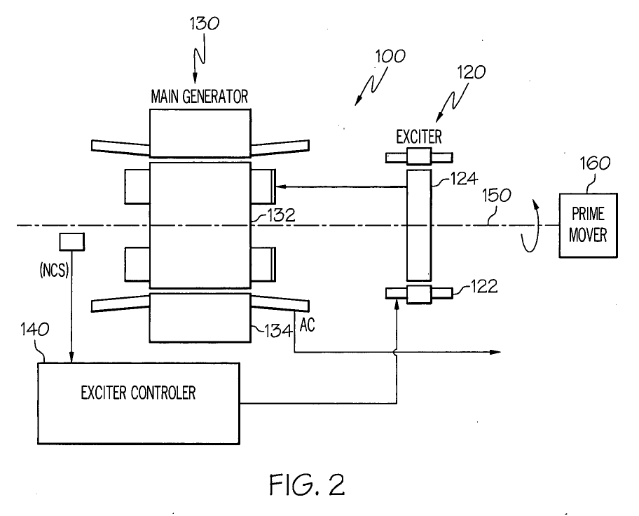

Before proceeding further, it will be appreciated that although the generator system 100 described above is implemented with a PMG 110, the generator system 100 could alternatively be implemented without the PMG 110. In this alternative embodiment, which is shown in FIG. 2, the generator system 100 includes a speed sensor 202 rather than the PMG 110. The speed sensor 202, which may be implemented using any one of numerous types of rotational speed sensors, is configured to sense the rotational speed of the shaft 150 and supply a speed signal (N_{S}) representative thereof to the exciter controller 140. Although the exciter controller 140 in the alternative embodiment also supplies AC power to the exciter stator 122, it does so in response to the speed signal from the speed sensor 202 rather than in response to the AC power supplied from the PMG 110. In both embodiments, however, it is noted that the signal supplied to the exciter controller 140, be it the AC power signal from the PMG 110 or the speed signal from the speed sensor 202, is representative of shaft rotational speed.

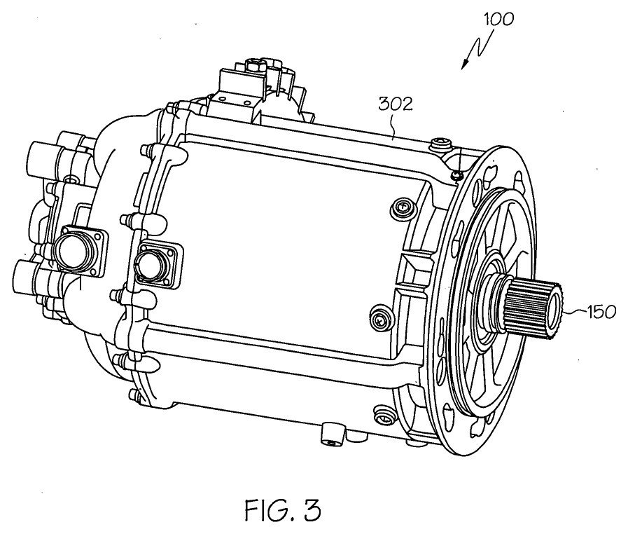

No matter whether the generator system 100 is implemented as shown in FIG. 1 or 2, the generator system 100, or at least portions of the system 100, is preferably housed within a generator housing 302, a perspective view of which is illustrated in FIG. 3.

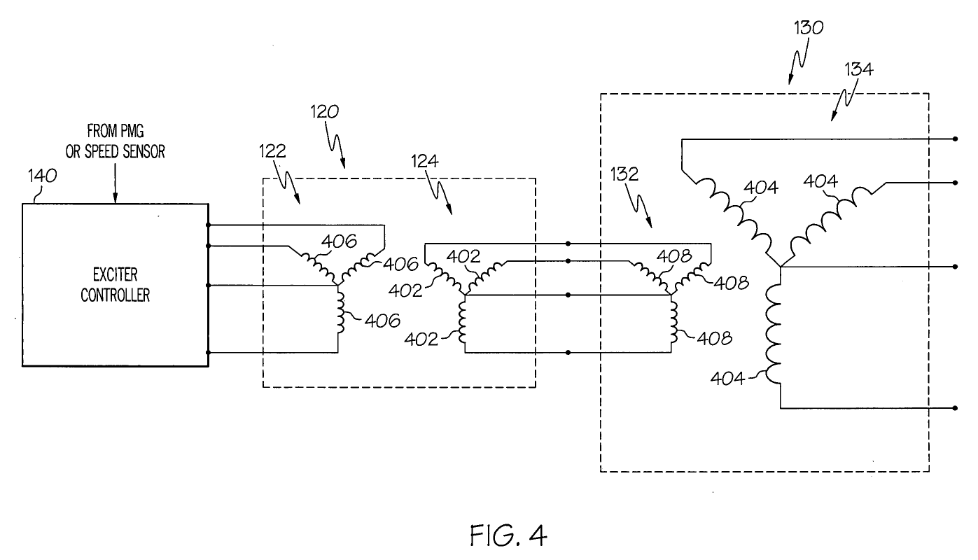

The exemplary AC generator systems 100 described above and shown in FIGS. 1 and 2 are, in some aspects, configured similar to a conventional brushless generator; however, each is quite different in certain other aspects. For example, and with reference now to FIG. 4, it is seen that the exciter rotor 124 and the main generator stator 134 are both implemented similar to a conventional brushless AC generator, whereas the exciter stator 122 and main generator rotor 132 are not. In particular, the exciter rotor 124 and the main generator stator 134, as in a conventional brushless AC generator, are both implemented with three phase exciter field windings 402 and three phase main stator windings 404, respectively. Conversely, the exciter stator 122 and the main generator rotor 132, rather than being implemented with single phase windings, as in a conventional brushless AC generator, are implemented with three phase exciter stator windings 406 and three phase main rotor field windings 408, respectively. Another difference from a conventional brushless AC generator system is that there are no rotating rectifier assemblies coupled between the exciter and the rotor. Rather, the exciter rotor windings 402 are directly coupled to the main rotor field windings 408.

The exciter controller 140 is implemented, at least in part, as a power converter circuit that is configured, in response to the signal supplied to it from either the PMG 110 or the speed sensor 202, to supply variable-frequency, three-phase excitation to the exciter stator windings 406, with either a relatively positive or negative phase sequence. It will be appreciated that relatively negative phase sequence excitation, as used herein, is excitation that is supplied in a direction opposite that which the exciter rotor 124 is rotating, and relatively positive sequence excitation, as used herein, is excitation that is supplied in a direction the same as which the exciter rotor 124 is rotating.

As will be described below, the excitation frequency and phase sequence that the exciter controller 140 supplies to the exciter stator windings 406 depends upon the rotational speed at which the prime mover 160 is rotating the shaft 150 (and thus the PMG rotor 112, the exciter rotor 124, and the main generator rotor 132), upon the number of poles with which the exciter 120 and the main generator 130 are implemented, and upon the desired frequency that the generator system 100 is to supply. In the depicted embodiment, the prime mover 160 is configured to rotate the shaft 150 at a rotational speed of between about 1,200 rpm and about 4,800 rpm, the exciter 120 is implemented as a 10-pole exciter and the main generator 130 is implemented as a 4-pole generator, and the desired constant output frequency from the generator system 100 is 400 Hz.

A description will now be provided as to how the above-described generator system 100, with the above-noted 4:1 speed variation, the 10-pole exciter 120, and the 4-pole main generator 130, can generate AC power at a constant frequency of 400 Hz. Before doing so, however, it will be appreciated that this speed variation, exciter implementation, main generator implementation, and constant output frequency are merely exemplary. Indeed, the generator system 100 could be driven at over any one of numerous rotational speed ranges, it could be configured with exciters and/or main generators having any one of numerous other numbers of poles, and it could be configured to generate AC power at any one of numerous other constant frequency values. Moreover, the exciter 120 and main generator 130 could be implemented with either an unequal number of poles, as described below, or with an equal number of poles.

Turning now to the description, when the prime mover 160 is rotating the shaft 150 at 1,200 rpm, the PMG 110 or the speed sensor 202 supplies a signal representative of this rotational speed to the exciter controller 140. In response, the exciter controller 140 supplies the exciter stator windings 406 with 260 Hz, negative sequence, three-phase excitation. The 10-pole exciter rotor 124, in response to this excitation, generates rotor current at a frequency of (100+260) Hz, or 360 Hz, and the main generator rotor 132 generates a main generator air gap flux at a frequency of (40+360) Hz, or 400 Hz. Thus, the generator stator 134 supplies AC current at 400 Hz.

It will be appreciated that the 100 Hz frequency that the 260 Hz excitation frequency is added to is the frequency the exciter rotor 124 would generate at a rotational speed of 1,200 rpm, if the stator windings 406 were supplied with DC excitation. Similarly, if the 4-pole main generator rotor 132 were supplied with DC excitation, as in a conventional brushless AC generator, the generated air gap flux at a rotational speed of 1,200 rpm would be 40 Hz. However, since the main generator rotor 132 is, by virtue of its connection to the exciter rotor 124, being supplied with AC excitation at a frequency of 360 Hz, the resultant main generator air gap flux is instead (40+360) Hz, or 400 Hz.

Likewise, when the prime mover 160 is rotating the shaft 150 at 4,800 rpm, the PMG 110 or the speed sensor 202 supplies a signal representative of this rotational speed to the exciter controller 140. In response, the exciter controller 140 supplies the exciter stator windings 406 with 160 Hz, positive sequence, three-phase phase excitation. The 10-pole exciter rotor 124, in response to this excitation, generates rotor current at a frequency of (400−160) Hz, or 240 Hz, and the main generator rotor 132 generates a main generator air gap flux at a frequency of (160+240) Hz, or 400 Hz. Thus, the generator stator 134 continues supplying AC current at 400 Hz.

It will once again be appreciated that the 400 Hz frequency from which the 160 Hz is subtracted is the frequency the exciter rotor 124 would generate at a rotational speed of 4800 rpm, if the stator windings 406 were supplied with DC excitation. And again, if the 4-pole main generator rotor 132 were supplied with DC excitation, the generated air gap flux at a rotational speed of 4,800 rpm would be 160 Hz.

The AC generator system and method described herein supplies relatively constant frequency AC power when the generator is driven by a variable speed prime mover, by independently controlling the field rotational speeds. The disclosed generator system and method can be implemented with no restrictions on the number of poles for the exciter or main generator.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A generator system, comprising:
a main generator rotor configured to rotate at a variable rotational speed, the main generator rotor having a plurality of main generator rotor windings wound thereon that, upon electrical excitation thereof, generate an electromagnetic flux;
an exciter rotor configured to rotate at the variable rotational speed and having a plurality of exciter rotor windings wound thereon, the exciter rotor windings electrically connected to the main generator rotor windings and configured, upon electrical excitation thereof, to supply the electrical excitation to the main generator rotor windings;
an exciter stator surrounding at least a portion of the exciter rotor, the exciter stator having a plurality of exciter stator windings wound thereon, the exciter stator windings configured, upon electrical excitation thereof, to electrically excite the exciter rotor windings; and
an exciter controller electrically coupled to at least the exciter stator windings, the exciter controller configured to determine the rotational speed of the main generator rotor and the exciter rotor and, based on the determined rotational speed, to supply electrical excitation to the exciter stator windings that results in the main generator rotor windings generating the electromagnetic flux at a substantially constant, predetermined frequency.

2. The generator system of claim 1, wherein:
the main generator rotor and the exciter rotor are configured to rotate at the variable rotational speed in a first direction;
the electrical excitation supplied to the exciter stator is multi-phase AC excitation having a phase sequence; and
the exciter controller supplies the multi-phase AC electrical excitation to the exciter stator windings in a phase sequence that is in either the first direction or a second direction opposite the first direction.

3. The generator system of claim 1, further comprising:
a main generator stator at least partially surrounding the main generator rotor, the main generator stator having a plurality of main stator windings wound thereon.

4. The generator system of claim 3, wherein the generated electromagnetic flux induces AC current in the main stator windings at the constant, predetermined frequency.

5. The generator system of claim 1, further comprising:
a permanent magnet generator (PMG) mounted on the shaft and configured, upon rotation thereof, to supply an signal to the exciter controller that is representative of the rotational speed of the shaft,
wherein the exciter controller determines the rotational speed of the shaft based at least in part on the signal supplied from the PMG.

6. The generator system of claim 1, further comprising:
a speed sensor configured to sense the rotational speed of the shaft and supply a speed signal representative thereof to the exciter controller,
wherein the exciter controller determines the rotational speed of the shaft based at least in part on the speed signal.

7. The generator system of claim 1, wherein:
the main generator rotor is implemented as a N-pole rotor;
the exciter rotor is implemented as a M-pole rotor; and
N and M are each integers greater than one.

8. The generator system of claim 7, wherein N is unequal to M.

9. The generator system of claim 7, wherein N is equal to M.

10. The generator system of claim 1, further comprising:
a generator housing enclosing at least portions of the main generator rotor, the exciter rotor, and the exciter stator.

11. The generator system of claim 10, further comprising:
a shaft rotationally mounted within the generator housing and supporting at least the main generator rotor and the exciter rotor thereon.

12. The generator system of claim 11, further comprising:
a prime mover coupled to the shaft and configured to rotate the shaft at the variable rotational speed.

13. A generator system, comprising:
a housing;
a shaft rotationally mounted within the housing and configured to rotate at a variable rotational speed;
a main generator stator mounted within the housing and having a plurality of main stator windings wound thereon;
a main generator rotor mounted on the shaft and disposed at least partially within the main stator, the main generator rotor having a plurality of main generator rotor windings wound thereon that, upon electrical excitation thereof, generate an air gap flux;
an exciter rotor mounted on the shaft, the exciter rotor having a plurality of exciter rotor windings wound thereon, the exciter rotor windings electrically connected to the main generator rotor windings and configured, upon electrical excitation thereof, to supply the electrical excitation to the main generator rotor windings;
an exciter stator surrounding at least a portion of the exciter rotor, the exciter stator having a plurality of exciter stator windings wound thereon, the exciter stator windings configured, upon electrical excitation thereof, to electrically excite the exciter rotor windings; and
an exciter controller electrically coupled to at least the exciter stator windings, the exciter controller configured to determine the rotational speed of the shaft and, based on the determined rotational speed, to supply electrical excitation to the exciter stator windings that results in the main generator rotor windings generating the air gap flux at a substantially constant, predetermined frequency.

14. The generator system of claim 13, wherein:
the main generator rotor and the exciter rotor are configured to rotate at the variable rotational speed in a first direction;
the electrical excitation supplied to the exciter stator is multi-phase AC excitation having a phase sequence; and
the exciter controller supplies the multi-phase AC electrical excitation to the exciter stator windings in a phase sequence that is in either the first direction or a second direction opposite the first direction.

15. The generator system of claim 13, further comprising:
a permanent magnet generator (PMG) mounted on the shaft and configured, upon rotation thereof, to supply a signal to the exciter controller that is representative of the rotational speed of the shaft,
wherein the exciter controller determines the rotational speed of the shaft based at least in part on the signal supplied from the PMG.

16. The generator system of claim 13, further comprising:
a speed sensor configured to sense the rotational speed of the shaft and supply a speed signal representative thereof to the exciter controller,
wherein the exciter controller determines the rotational speed of the shaft based at least in part on the speed signal.

17. The generator system of claim 13, wherein:
the main generator rotor is implemented as a N-pole rotor;
the exciter rotor is implemented as a M-pole rotor; and
N and M are each integers greater than one.

18. The generator system of claim 17, wherein N is unequal to M.

19. The generator system of claim 17, wherein N is equal to M.

20. A generator system, comprising:
a housing;
a shaft rotationally mounted within the housing and configured to rotate at a variable rotational speed;
a main generator stator mounted within the housing and having a plurality of main stator windings wound thereon;
a main generator rotor mounted on the shaft and disposed at least partially within the main stator, the main generator rotor having a plurality of main generator rotor windings wound thereon that, upon electrical excitation thereof, generate an air gap flux;
an exciter rotor mounted on the shaft, the exciter rotor having a plurality of exciter rotor windings wound thereon, the exciter rotor windings electrically connected to the main generator rotor windings and configured, upon electrical excitation thereof, to supply the electrical excitation to the main generator rotor windings;
an exciter stator surrounding at least a portion of the exciter rotor, the exciter stator having a plurality of exciter stator windings wound thereon, the exciter stator windings configured, upon electrical excitation thereof, to electrically excite the exciter rotor windings;
a speed signal source configured to supply a speed signal representative of the rotational speed of the shaft; and
an exciter controller electrically coupled to at least the exciter stator windings and coupled to receive the speed signal, the exciter controller configured, in response to the speed signal, to determine the rotational speed of the shaft and, based on the determined rotational speed, to supply electrical excitation to the exciter stator windings that results in the main generator rotor windings generating the air gap flux at a substantially constant, predetermined frequency.
